(19) United States
(12) Patent Application Publication
(10) Pub. No.: US 2006/0140260 A1
(43) Pub. Date: Jun. 29, 2006

(54) Power supply line communication modem and power supply line communication system

(75) Inventors: Masaru Wasaki, Ichihara-shi (JP); Hitomi Wasaki, Ichihara-shi (JP); Yoshihiro Saitoh, Chuo-ku (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/545,681

(22) PCT Filed: Mar. 2, 2004
(86) PCT No.: PCT/JP04/02540

§ 371 Date: Aug. 15, 2005

(30) Foreign Application Priority Data
Mar. 3, 2003 (JP) 2003-055921

(51) Int. Cl. H04L 5/16

(52) U.S. Cl. 375/219; 307/10.1; 340/310.13; 307/3

(57) ABSTRACT

A modem for power-line communications (20A) comprises input/output terminals (71a and 71b) and input/output terminals (72a to 72d). The input/output terminals (71a and 71b) are connected to a power line and perform input and output of power-line communications signals. The input/output terminals (72a to 72d) perform input and output of data signals from and to a communications apparatus through a cable. The modem (20A) further comprises: a modem main body (73); a common mode filter (80) provided between the modem main body (73) and the input/output terminals (71a and 71b); and a common mode filter (90) provided between the modem main body (73) and the input/output terminals (72a to 72d).

### TECHNICAL FIELD

The present invention relates to a modem for power-line communications used in a power-line communications system that performs communications among a plurality of apparatuses through power lines as transmission lines of signals, and to the power-line communications system incorporating the modem for power-line communications.

### BACKGROUND ART

The needs for data communications in homes have been increasing to accomplish objectives such as the sharing of peripheral equipment of computers and the sharing of data including documents, freeze-frame pictures and moving pictures, and objectives such as games and the Internet. The demands for communications network systems therefore exist not only in offices but also in ordinary households. Communications schemes that can be chosen for constructing a communications network system in the households include the communications scheme utilizing radio, the communications scheme utilizing wires, and the power-line communications scheme utilizing power lines. Among these schemes, the power-line communications scheme has such benefits that no cost of installing wiring is required since existing power lines are used and that the appearance inside the house is not affected.

However, the power-line communications scheme has a problem that communications interference could be caused by noise emerging from apparatuses connected to the power line. A variety of types of measures against noise have been therefore proposed for the power-line communications system.

For example, the Published Unexamined Japanese Patent Application No. 2002-290288 and the Published Unexamined Japanese Patent Application No. 2002-290289 disclose a technique for providing a noise filter in the power-line communications system between a power line and an apparatus connected to the power line and developing noise.

In the power line communications system, a communications apparatus that performs communications through the use of a power line is typically connected to the power line through a modem for power-line communications. In such a case, the communications apparatus is connected to the modem through a cable used for data communications such as a universal serial bus (USB). The communications apparatus herein described includes an information processing apparatus such as a computer and an electrical apparatus having a communications function, for example. The modem for power-line communications performs input and output of power-line communications signals from and to the power line and performs input and output of data communications signals from and to the cable used for data communications. The power-line communications signals and the data communications signals are both normal mode signals.

A problem that will now be described occurs in the above-mentioned system including the modem for power-line communications. In this system, a stray capacitance is produced between the power line and the ground and/or between the cable used for data communications and the ground, for example. Then, a common mode current is fed through the stray capacitance to the ground when a normal mode signal passes through the power line or the cable. As a result, common mode noise emerges along the power line or the cable. According to prior art, it is impossible to effectively suppress common mode noise resulting from the stray capacitance in such a manner.

### DISCLOSURE OF THE INVENTION

It is an object of the invention to provide a modem for power-line communications for effectively suppressing common mode noise resulting from a stray capacitance between the ground and a power line or a cable connected to the modem, and to provide a power-line communications system incorporating the modem.

A modem for power-line communications of the invention is provided between a power line and a communications apparatus performing communications through the use of the power line. The modem of the invention comprises: a first input/output connected to the power line and performing input and output of power-line communications signals from and to the power line; a second input/output connected to the communications apparatus and performing input and output of data signals from and to the communications apparatus; a modem main body that generates a power-line communications signal by modulating carrier waves based on a data signal received at the second input/output and outputs the power line communications signal to the first input/output, and that demodulates a data signal from a power-line communications signal received at the first input/output and outputs the data signal demodulated to the second input/output; and common mode filters one of which is provided between the modem main body and the first input/output and the other of which is provided between the modem main body and the second input/output.

In the present patent application, the communications apparatus widely means apparatuses performing communications through the use of power lines and includes information processing apparatuses such as computers and electrical apparatuses having a communications function.

In the modem of the invention, passing of common mode currents is suppressed at both of the first input/output and the second input/output by the common mode filters one of which is provided between the modem main body and the first input/output and the other of which is provided between the modem main body and the second input/output. It is thereby possible to suppress the emergence of common mode noise.

In the modem of the invention, the absolute value of impedance of each of the common mode filters at a frequency of 2.0 MHz may be 160 ohms or greater.

A power-line communication system of the invention comprises: a power line; a communications apparatus performing communications through the use of the power line; and the modem of the invention provided between the communications apparatus and the power line.

Other and further objects, features and advantages of the invention will appear more fully from the following description.

### BRIEF DESCRIPTION OF THE DRAWINGS

FIG. 1 is a schematic diagram illustrating an example of configuration of a modem for power-line communications of an embodiment of the invention.

FIG. 2 is a block diagram illustrating an example of configuration of a power-line communications system in which the modem for power-line communications of the embodiment of the invention is employed.

FIG. 3 is a view for describing a cause of common mode noise in the power-line communications system of FIG. 2.

FIG. 4 is a schematic diagram illustrating an example of configuration of a power source of a communications apparatus of FIG. 2.

FIG. 5 is a schematic diagram for describing an impedance of a common mode filter of FIG. 1.

FIG. 6 is a schematic diagram for describing an impedance of the common mode filter of FIG. 1.

FIG. 7 is a schematic diagram for describing an impedance of the common mode filter of FIG. 1.

### BEST MODE FOR CARRYING OUT THE INVENTION

A preferred embodiment of the invention will now be described in detail with reference to the accompanying drawings. Reference is now made to FIG. 2 to describe an example of configuration of a power-line communications system in which a modem for power-line communications of the embodiment of the invention is employed. The power-line communications system of FIG. 2 comprises: power lines 1A to 1G; two communications apparatuses 10A and 10B performing communications through the use of the power lines 1A to 1G; and modems 20A and 20B for power-line communications of the embodiment. The communications apparatuses 10A and 10B may be information processing apparatuses such as computers or electrical apparatuses having a communications function. Although each of the power lines 1A to 1G is indicated with a single line in FIG. 2, each of them actually includes a plurality of conductor lines.

The power line 1B is connected to the power line 1A. The power line 1C has an end connected to the power line 1B and the other end connected to the modem 20A. The power line 1D has an end connected to the power line 1B and the other end connected to the modem 20B.

The power line 1E is connected to the power line 1A. The power line 1F has an end connected to the power line 1E and the other end connected to the communications apparatus 10A. The power line 1G has an end connected to the power line 1E and the other end connected to the communications apparatus 10B.

The communications apparatus 10A incorporates a power source 11A and a communications interface 12A. Similarly, the communications apparatus 10B incorporates a power source 11B and a communications interface 12B. The power sources 11A and 11B are connected to the power lines 1F and 1G, respectively, and receive power supply through the power lines 1F and 1G. The interfaces 12A and 12B perform transmission and reception of data signals to and from the modems 20A and 20B, respectively.

The modem 20A has a first input/output 21A and a second input/output 22A. The first input/output 21A performs input and output of power-line communications signals from and to the power line 1C. The second input/output 22A is connected to the interface 12A of the communications apparatus 10A through a cable 3A for data communications such as a USB. The second input/output 22A performs input and output of data signals from and to the interface 12A through the cable 3A.

The modem 20A generates a power-line communications signal by modulating carrier waves based on a data signal received at the second input/output 22A, and outputs the power-line communications signal from the first input/output 21A. In addition, the modem 20A demodulates a data signal from a power-line communications signal received at the first input/output 21A, and outputs from the second input/output 22A the data signal demodulated.

Similarly, the modem 20B has a first input/output 21B and a second input/output 22B. The first input/output 21B performs input and output of power-line communications signals from and to the power line 1D. The second input/output 22B is connected to the interface 12B of the communications apparatus 10B through a cable 3B for data communications such as a USB. The second input/output 22B performs input and output of data signals from and to the interface 12B through the cable 3B.

The modem 20B generates a power-line communications signal by modulating carrier waves based on a data signal received at the second input/output 22B, and outputs the power-line communications signal from the first input/output 21B. In addition, the modem 20B demodulates a data signal from a power-line communications signal received at the first input/output 21B, and outputs from the second input/output 22B the data signal demodulated.

In FIG. 2, arrows with numerals 4A, 4B and 4C indicate power-line communications signals. Arrows with numerals 5A and 5B indicate data signals. The power-line communications signals and the data signals are both normal mode signals.

In the power-line communications system of FIG. 2, the communications apparatuses 10A and 10B perform communications with each other through the cables 3A and 3B, the modems 20A and 20B, and the power lines 1B, 1C and 1D.

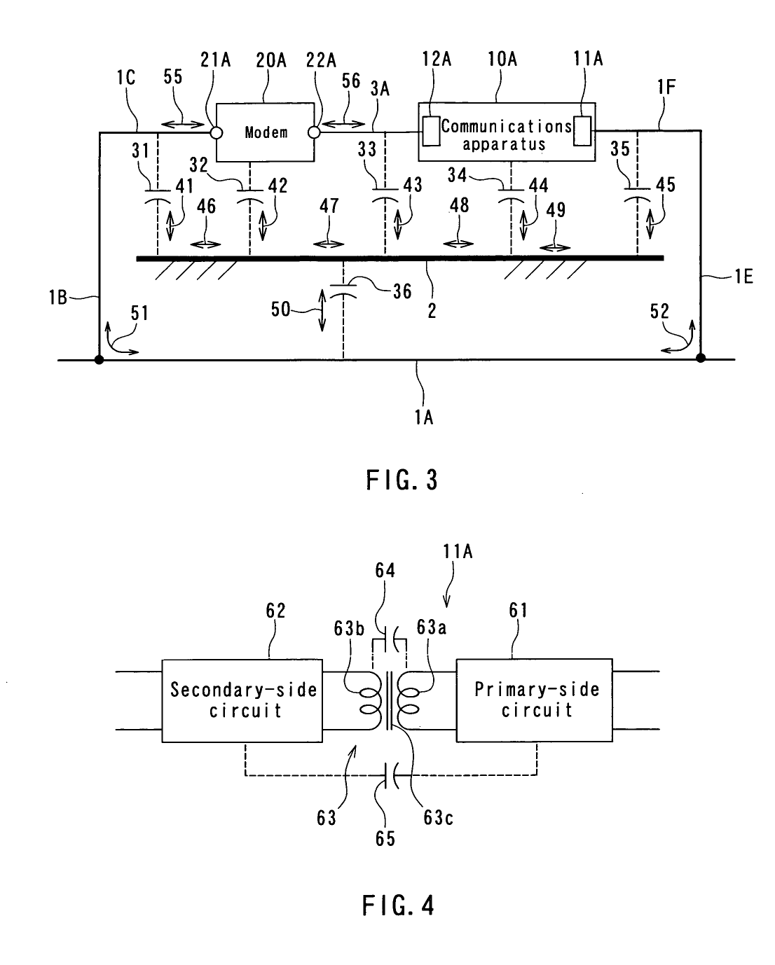

Reference is now made to FIG. 3 to describe a cause of common mode noise in the power-line communications system of FIG. 2. FIG. 3 illustrates the modem 20A, the communications apparatus 10A, the cable 3A, and the power lines 1A, 1B, 1C, 1E and 1F among the components of the power line communications system of FIG. 2, and illustrates a ground 2. Stray capacitance develops at various locations in the power-line communications system. FIG. 3 illustrates: a stray capacitance 31 between the power line 1C and the ground 2; a stray capacitance 32 between the enclosure of the modem 20A and the ground 2; a stray capacitance 33 between the cable 3A and the ground 2; a stray capacitance 34 between the enclosure of the communications apparatus 10A and the ground 2; a stray capacitance 35 between the power line 1F and the ground 2; and a stray capacitance 36 between the power line 1A and the ground 2. The enclosure of the modem 20A is used as a frame ground of the modem 20A.

In the system of FIG. 3, when a normal mode signal passes through the power line 1C, a common mode current is fed to the ground 2 through the stray capacitance 31. The common mode current is fed through a closed path including the inputs/outputs 21A and 22A and the other stray capacitances in addition to the stray capacitance 31. When a normal mode signal passes through the cable 3A, a common mode current is fed to the ground 2 through the stray capacitance 33. The common mode current is fed through a closed path including the inputs/outputs 21A and 22A and the other stray capacitances in addition to the stray capacitance 33. In FIG. 3, the arrows with numerals 41 to 52 indicate the above-mentioned common mode currents. When such a common mode current is fed, a common mode current 55 is fed to the power line 1C, and a common mode current 56 is fed to the cable 3A. These common mode currents 55 and 56 cause common mode noise.

A common mode current passes through the communications apparatus 10A in some cases. This will now be described, referring to FIG. 4. FIG. 4 is a schematic diagram illustrating an example of configuration of the power source 11A of the communications apparatus 10A. In this example, the power source 11A comprises: a primary-side circuit 61 connected to the power line 1F; a secondary-side circuit 62 supplying power to each part of the communications apparatus 10A; and a transformer 63 connecting the primary-side circuit 61 to the secondary-side circuit 62. The transformer 63 has: a primary winding 63a connected to the primary-side circuit 61; a secondary winding 63b connected to the secondary-side circuit 62; and a magnetic core 63c coupling the primary winding 63a to the secondary winding 63b. In the power source 11A, for example, a stray capacitance 64 is produced between the primary winding 63a and the secondary winding 63b, and a stray capacitance 65 is produced between the primary-side circuit 61 and the secondary-side circuit 62. A common mode current passes through the power source 11A via the stray capacitances 64 and 65, and thereby passes through the communications apparatus 10A.

To suppress common mode noise in the system of FIG. 3, it is required to suppress the common mode currents 55 and 56. In the modem 20A of the embodiment, passing of common mode currents is suppressed through the use of a common mode filter at each of the first input/output 21A and the second input/output 22A, which will be described in detail later.

Even if a common mode filter is provided at a location other than the inputs/outputs 21A and 22A, it is impossible to sufficiently suppress common mode noise. For example, if a common mode filter is provided between the cable 3A and the interface 12A of the communications apparatus 10A, a common mode current is fed through the stray capacitance 33 between the cable 3A and the ground 2. The common mode current flows through the closed path including the stray capacitances 31 and 33 and the inputs/outputs 21A and 22A, for example. As a result, common mode noise emerges.

It is impossible to sufficiently suppress common mode noise by providing a common mode filter at only one of the first input/output 21A and the second input/output 22A. For example, if a common mode filter is provided at the first input/output 21A, a common mode current is fed through a closed path including: two or more of the stray capacitances 32 to 36; the enclosure of the modem 20A; and the input/output 22A. As a result, common mode noise emerges. If a common mode filter is provided at the second input/output 22A, a common mode current is fed through a closed path including: at least one of the stray capacitances 31 and 36; the stray capacitance 32; the enclosure of the modem 20A; and the input/output 21A. As a result, common mode noise emerges.

If passing of the common mode current is blocked at both of the first input/output 21A and the second input/output 22A, it is possible to block the path of the common mode current. Therefore, it is possible to effectively suppress common mode noise by suppressing passing of the common mode current by using the common mode filters at both of the first input/output 21A and the second input/output 22A, as disclosed in the embodiment.

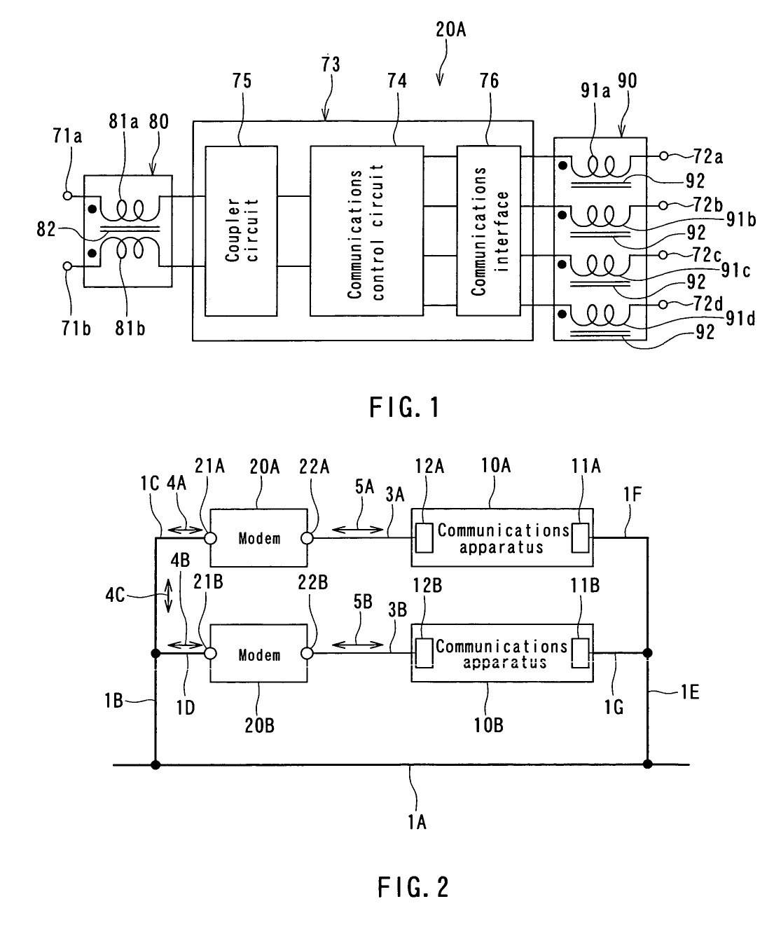

Reference is now made to FIG. 1 to describe an example of configuration of the modem 20A for power-line communications of the embodiment. The modem 20B of FIG. 2 has a configuration the same as that of the modem 20A.

The modem 20A of FIG. 1 comprises input/output terminals 71a and 71b and input/output terminals 72a to 72d. The input/output terminals 71a and 71b are connected to the power line 1C and perform input and output of power-line communications signals from and to the power line 1C. The input/output terminals 71a and 71b correspond to the first input/output 21A of FIG. 2. The input/output terminals 72a to 72d are connected to the cable 3A and perform input and output of data signals from and to the communications apparatus 10A connected to the terminals 72a to 72d through the cable 3A. The input/output terminals 72a to 72d correspond to the second input/output 22A of FIG. 2.

The modem 20A further comprises: a modem main body 73; a common mode filter 80 provided between the modem main body 73 and the input/output terminals 71a and 71b; and a common mode filter 90 provided between the modem main body 73 and the input/output terminals 72a to 72d.

The modem main body 73 incorporates: a communications control circuit 74; a coupler circuit 75 provided between the control circuit 74 and the common mode filter 80; and a communications interface 76 provided between the control circuit 74 and the common mode filter 90.

The coupler circuit 75 blocks passing of electric power and allows power-line communications signals to pass. The interface 76 performs transmission and reception of data signals to and from the interface 12A of the communications apparatus 10A through the cable 3A.

The control circuit 74 generates a power-line communications signal by modulating carrier waves based on a data signal received from the interface 76, and outputs the power-line communications signal to the coupler circuit 75. In addition, the control circuit 74 demodulates a data signal from a power-line communications signal received from the coupler circuit 75, and outputs the data signal demodulated to the interface 76.

As thus described, the modem main body 73 generates a power-line communications signal by modulating carrier waves based on data signals received at the input/output terminals 72a to 72d, and outputs the power-line communications signal to the input/output terminals 71a and 71b. In addition, the modem main body 73 demodulates a data signal from a power-line communications signal received at the input/output terminals 71a and 71b, and outputs the data signal demodulated to the input/output terminals 72a to 72d.

The common mode filter 80 incorporates two windings 81a and 81b and a magnetic core 82 coupling the two windings 81a and 81b to each other. The windings 81a and 81b have ends connected to the input/output terminals 71a and 71b, respectively, and the other ends connected to the coupler circuit 75. The windings 81a and 81b are wound around the core 82 in such directions that, when magnetic fluxes are induced in the core 82 by currents flowing through the windings 81a and 81b when a common mode current is fed to the windings 81a and 81b, the directions of these fluxes are identical. The windings 81a and 81b thereby suppress common mode noise and allow normal mode signals to pass.

The common mode filter 90 incorporates four windings 91a to 91d and a magnetic core 92 coupling the four windings 91a to 91d to one another. The windings 91a to 91d have ends connected to the input/output terminals 72a to 72d, respectively, and the other ends connected to the interface 76. The windings 91a to 91d are wound around the core 92 in such directions that, when magnetic fluxes are induced in the core 92 by currents flowing through the windings 91a to 91d when a common mode current is fed to the windings 91a to 91d, the directions of these fluxes are identical. The windings 91a to 91d thereby suppress common mode noise and allow normal mode signals to pass.

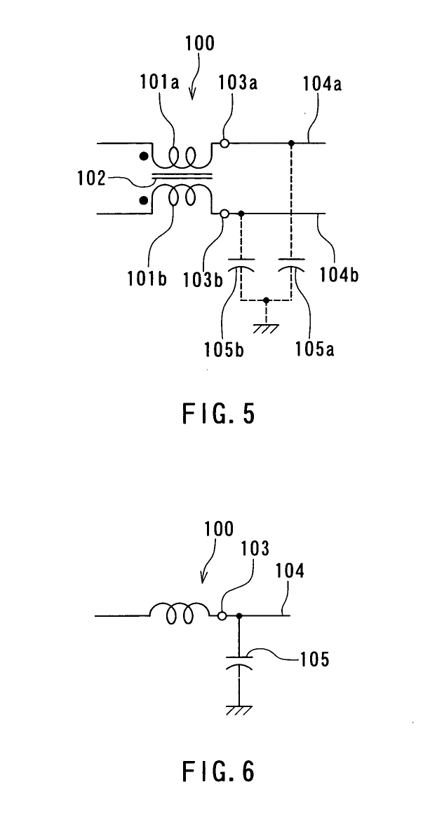

Reference is now made to FIG. 5 to FIG. 7 to describe the impedance of the common mode filters 80 and 90. FIG. 5 is a schematic diagram illustrating a common mode filter 100 and conductor lines 104a and 104b connected thereto. The common mode filter 100 represents the common mode filters 80 and 90. The conductor lines 104a and 104b represent the power line 1C and the cable 3A.

The common mode filter 100 incorporates two windings 101a and 101b and a magnetic core 102 coupling the two windings 101a and 101b to each other. The conductor line 104a is connected to the winding 101a through a terminal 103a. The conductor line 104b is connected to the winding 101b through a terminal 103b. Here, it is assumed that stray capacitances 105a and 105b are created between the ground and the conductor lines 104a and 104b, respectively.

FIG. 6 is a schematic diagram illustrating the circuit of FIG. 5 in a simplified manner. In FIG. 6, the common mode filter 100 is connected to a conductor line 104 through a terminal 103. A stray capacitance 105 is created between the conductor line 104 and the ground. The stray capacitance 105 is a combination of the stray capacitances 105a and 105b of FIG. 5.

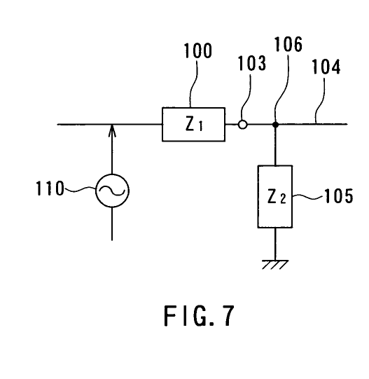

FIG. 7 is an equivalent circuit of the circuit shown in FIG. 6. As shown in FIG. 7, the absolute value of the impedance of the common mode filter 100 is Z₁, and the absolute value of the impedance of the stray capacitance 105 is Z₂. Here, a case is considered in which a high frequency voltage source 110 applies a high frequency voltage V_{A} to a side of the common mode filter 100 opposite to the terminal 103. In this case, the voltage V_{N} at a node 106 between the conductor line 104 and the stray capacitance 105 is given by the following equation (1).
V_{N}=V_{A}×{Z₂/(Z₁+Z₂)} (1)

The high frequency voltage source 110 corresponds to the modem main body 73 of FIG. 1. The frequency of the high frequency voltage V_{A} corresponds to the frequency of a normal mode signal. The voltage V_{N} corresponds to the voltage of common mode noise emerging along the conductor line 104. As the equation (1) indicates, the greater the absolute value Z₁ of the impedance of the common mode filter 100, the smaller is the voltage of common mode noise. To suppress common mode noise, it is preferred that the absolute value Z₁ of the impedance of the common mode filter 100 is equal to or greater than the absolute value Z₂ of the impedance of the stray capacitance 105.

The absolute value Z₂ of the impedance of the stray capacitance 105 at the frequency of a normal mode signal is given by the following equation (2) where the angular frequency of the normal mode signal is ω and the capacitance of the stray capacitance 105 is Cs.
Z₂=1/ωCs (2)

Consequently, the absolute value Z₁ of the impedance of the common mode filter 100 is made equal to or greater than the absolute value Z₂ of the impedance of the stray capacitance 105 as long as the following equation (3) holds.
Z₁≧1/ωCs (3)

The greater the capacitance Cs of the stray capacitance 105, the smaller is the absolute value Z₂ of the impedance. As a result, the current flowing through the stray capacitance 105 increases and the common mode noise becomes a problem. The capacitance of stray capacitance created along the cable 3A is typically around 100 pF. Therefore, it is assumed here that the upper limit of the capacitance Cs of the stray capacitance 105 is 500 pF. In addition, it is assumed that the lower limit of frequency band used in power-line communications is 2.0 MHz and this is the lower limit of frequency band of normal mode signals. In this case, as denoted by the equation (3), it is preferred that the absolute value Z₁ of the impedance of the common mode filter 100 at the frequency of 2.0 MHz is equal to or greater than 160 ohms.

The left side of the equation (3) is proportional to the angular frequency ω while the right side is inversely proportional to the angular frequency ω. Therefore, the equation (3) holds in the entire frequency band if the equation (3) holds at the frequency of the lower limit of the frequency band used for power-line communications unless there is no reduction in characteristics of the common mode filter 100.

According to the modem 20A for power-line communications of the embodiment as thus described, the common mode filter 80 is provided between the modem main body 73 and the input/output terminals 71a and 71b. In addition, the common mode filter 90 is provided between the modem main body 73 and the input/output terminals 72a to 72d. As a result, according to the embodiment, it is possible to suppress passing of common mode currents at both of the first input/output 21A connected to the power line 1C and the second input/output 22A connected to the cable 3A. It is thereby possible to effectively suppress common mode noise resulting from the stray capacitance between the ground and the power line or cable connected to the modem 20A in the power-line communications system.

The present invention is not limited to the foregoing embodiment but may be practiced in still other ways. For example, the modem for power-line communications of the invention may be provided in a single enclosure together with a communications apparatus.

According to the modem for power-line communications and the power-line communications system of the invention as thus described, the common mode filter is provided at each of the location between the modem main body and the first input/output connected to the power line and the location between the modem main body and the second input/output connected to the communications apparatus. As a result, according to the invention, it is possible to effectively suppress common mode noise resulting from the stray capacitance between the ground and the power line or cable connected to the modem.

Obviously many modifications and variations of the present invention are possible in the light of the above teachings. It is therefore to be understood that within the scope of the appended claims the invention may be practiced otherwise than as specifically described.

1. A modem for power-line communications provided between a power line and a communications apparatus performing communications through the use of the power line, the modem comprising:
a first input/output connected to the power line and performing input and output of power-line communications signals from and to the power line;
a second input/output connected to the communications apparatus and performing input and output of data signals from and to the communications apparatus;
a modem main body that generates a power-line communications signal by modulating carrier waves based on a data signal received at the second input/output and outputs the power-line communications signal to the first input/output, and that demodulates a data signal from a power-line communications signal received at the first input/output and outputs the data signal demodulated to the second input/output; and
common mode filters one of which is provided between the modem main body and the first input/output and the other of which is provided between the modem main body and the second input/output.

2. The modem according to claim 1, wherein an absolute value of impedance of each of the common mode filters at a frequency of 2.0 MHz is 160 ohms or greater.

3. A power-line communications system comprising:
a power line;
a communications apparatus performing communications through the use of the power line; and
a modem for power-line communications provided between the communications apparatus and the power line, the modem incorporating:
a first input/output connected to the power line and performing input and output of power-line communications signals from and to the power line;
a second input/output connected to the communications apparatus and performing input and output of data signals from and to the communications apparatus;
a modem main body that generates a power-line communications signal by modulating carrier waves based on a data signal received at the second input/output and outputs the power line communications signal to the first input/output, and that demodulates a data signal from a power-line communications signal received at the first input/output and outputs the data signal demodulated to the second input/output; and
common mode filters one of which is provided between the modem main body and the first input/output and the other of which is provided between the modem main body and the second input/output.
